(19) United States
(12) Patent Application Publication
(10) Pub. No.: US 2025/0343666 A1
(43) Pub. Date: Nov. 6, 2025

(54) SYSTEMS AND METHODS FOR ENHANCED WIRED TRANSMISSION

(71) Applicant: Air Wireless 5, Inc., Palo Alto, CA (US)

(72) Inventors: Jan Uddenfeldt, San Jose, CA (US); Lorenz Glatz, Vienna (AT)

(21) Appl. No.: 19/198,332

(22) Filed: May 5, 2025

Related U.S. Application Data
(60) Provisional application No. 63/643,162, filed on May 6, 2024.
(60) Provisional application No. 63/662,100, filed on Jun. 20, 2024.

(51) Int. Cl. H04L 5/14; H04B 1/44

(52) U.S. Cl. CPC H04L 5/1461; H04B 1/44

(57) ABSTRACT

A communication system for transmitting 5G signals over a wired network is provided. The communication system includes a 5G radio access network (RAN) component including a baseband unit (BBU) and a remote radio unit (RRU) operable to output one or more 3GPP frequency band signals; a frequency converter (FC) in wired communication with the RRU, the FC being operative in both time-division duplex (TDD) and frequency-division duplex (FDD) modes to convert each 3GPP frequency band signal into one or more cable-frequency bands for transport over a hybrid fiber-coaxial (HFC) network; an optical transmitter to convey the converted cable-frequency bands into the HFC network; and a corresponding FC at a subscriber home that converts the cable-frequency bands back into 3GPP frequency band signals for delivery to customer home equipment (CPE).

### CROSS REFERENCE TO RELATED APPLICATIONS

This application claims priority to U.S. Provisional Application No. 63/643,162, filed May 6, 2024, and claims priority to U.S. Provisional Application No. 63/662,100, filed Jun. 20, 2024. Each of the above-referenced applications is hereby incorporated by reference in its entirety.

### FIELD OF THE DISCLOSURE

The present disclosure relates to enhanced wired transmission, and more particularly, to systems and methods for transmitting through coaxial cable or fiber using wireless methodologies.

### BACKGROUND

The 5G NR (new radio) standard is a radio access technology developed by the 3rd Generation Partnership Project (3GPP) for the 5G mobile network. It is designed to be the global standard for the air interface of 5G networks. The purpose of the 5G NR standard is to provide faster and more reliable wireless communication than its predecessors, such as 4G LTE (fourth generation long-term evolution.) The main problem it solves is the increasing demand for high-speed, low-latency wireless communication in a world where more and more devices are connected to the Internet.

Coaxial cable is a type of electrical cable that is used to transmit high-frequency signals. It consists of a central conductor, which is surrounded by a dielectric insulator, which is then surrounded by a conductive shield. Coaxial cable is-among other use cases-commonly used in cable television networks for distribution of broadband internet, and video signals. While there are differences between the capabilities of cable and 5G, it would be useful to combine 5G's and cable's capabilities to create a common network architecture. Furthermore, improved coordination of 5G and cable would be useful to improve harmonization of networks and provide for increased economies of scale. The benefits of a harmonized network architecture lead to a harmonized service platform and to improved economies of scale from a cable perspective and a 5G perspective.

### BRIEF SUMMARY

In one aspect, a communication system for transmitting 5G signals over a wired network is provided. The communication system includes a 5G radio access network (RAN) component including a baseband unit (BBU) and a remote radio unit (RRU) operable to output one or more 3GPP frequency band signals; a frequency converter (FC) in wired communication with the RRU, the FC being operative in both time-division duplex (TDD) and frequency-division duplex (FDD) modes to convert each 3GPP frequency band signal into one or more cable-frequency bands for transport over a hybrid fiber-coaxial (HFC) network; an optical transmitter to convey the converted cable-frequency bands into the HFC network; and a corresponding FC at a subscriber home that converts the cable-frequency bands back into 3GPP frequency band signals for delivery to customer home equipment (CPE). The communication system may include additional, less, or alternate functionality, including that discussed elsewhere herein.

In another aspect, an amplifier apparatus for use in a 5G over cable system is provided. The apparatus includes an amplifier stage operable in a full-duplex (FDX) band and in a time-division duplex (TDD) band; an echo cancellation (EC) system coupled to both upstream and downstream paths to suppress interferences when downstream signals and upstream signals overlap; and a control module for time switching amplification between transmit and receive modes in TDD operation, the control module being responsive to a synchronization signal or to signal detectors that enable amplification only when a corresponding signal is present. The apparatus may include additional, less, or alternate functionality, including that discussed elsewhere herein.

A combined 5G radio and cable network system is provided. The system includes a 5G core and RAN equipment shared by both a wireless physical interface and a cable-frequency physical interface, wherein the RAN equipment includes a baseband unit and a radio receiving unit; one or more frequency converters that selectively route 3GPP signals to either a wireless antenna or into a cable; and customer premises equipment (CPE) operable to receive 5G signals via either the wireless physical interface or the cable-frequency physical interface. The system may include additional, less, or alternate functionality, including that discussed elsewhere herein.

Advantages will become more apparent to those skilled in the art from the following description of the preferred embodiments which have been shown and described by way of illustration. As will be realized, the present embodiments may be capable of other and different embodiments, and their details are capable of modification in various respects. Accordingly, the drawings and description are to be regarded as illustrative in nature and not as restrictive.

### BRIEF DESCRIPTION OF THE DRAWINGS

The Figures described below depict various aspects of the systems and methods disclosed therein. It should be understood that each Figure depicts an embodiment of a particular aspect of the disclosed systems and methods, and that each of the Figures is intended to accord with a possible embodiment thereof. Further, wherever possible, the following description refers to the reference numerals included in the following Figures, in which features depicted in multiple Figures are designated with consistent reference numerals.

There are shown in the drawings arrangements which are presently discussed, it being understood, however, that the present embodiments are not limited to the precise arrangements and are instrumentalities shown, wherein:

FIG. 1 illustrates a block diagram for a first architecture of a system for 5G over coaxial cable, in accordance with at least one embodiment.

FIG. 2 illustrates a block diagram for a second architecture of a system for 5G over coaxial cable, in accordance with at least one embodiment.

FIG. 3 illustrates a block diagram for a third architecture of a system for 5G over coaxial cable, in accordance with at least one embodiment.

FIG. 4 illustrates a block diagram for a fourth architecture of a system for 5G over coaxial cable, in accordance with at least one embodiment.

FIG. 5 illustrates a system for MIMO (multiple input, multiple output) with 5G over coaxial cable with the systems shown herein.

The Figures depict preferred embodiments for purposes of illustration only. One skilled in the art will readily recognize from the following discussion that alternative embodiments of the systems and methods illustrated herein may be employed without departing from the principles of the invention described herein.

### DETAILED DESCRIPTION OF THE DRAWINGS

The present embodiments may relate to, inter alia, network-based systems and methods that transmit through coaxial cable or fiber using wireless methodologies. In one example embodiment, the process may be performed by a transmission controller (TC) system. The TC system may include a midbox or interface between two or more computer devices transmitting over wired media. The wired media may include, but is not limited to, coaxial cable and fiber-optic cables. As described below in further detail, the TC system includes transmitters and receivers configured to use 5G, 4G, and 3G technologies normally used for wireless transmission over wired media.

The systems and methods described herein integrate 5G wireless technologies with hybrid fiber-coaxial (HFC) networks. The system employs frequency conversion techniques to map 5G frequency bands to HFC-compatible bands and utilizing bi-directional full duplex (FDX) and time division duplex (TDD) amplifiers to support both downstream and upstream traffic. These systems provide for bi-directional traffic in all bands for downstream and upstream with FDX (full duplex) and/or TDD (time division duplex) nodes and amplifiers. In some embodiments, existing amplifiers work with the systems and methods described herein. In other embodiments, amplifiers are modified to work with the 5G FDX and/or TDD systems. Depending on the needs of the system, the bi-directional traffic may be asymmetric or symmetric using the 5G TDD and FDX technologies.

Some 5G wireless high speed system use time division duplex (TDD), enabling duplex communication by allocating different time slots for uplink and downlink transmissions within the same frequency band. This allows for asymmetric traffic management, which is particularly advantageous in scenarios where uplink and downlink data rates differ significantly. In the context of HFC networks, TDD is adapted to manage bi-directional traffic over coaxial cables, ensuring efficient use of the available spectrum. In TDD, time rather than frequency is used to separate the transmission and reception of the signals, and thus a single frequency is assigned to a user for both directions to provide quasi-simultaneous bidirectional flow of information. For example, time division duplex separates uplink and downlink signals by matching full duplex communication over a half-duplex communication link. This method is highly advantageous in case there is an asymmetry of uplink and downlink data rates. TDD divides a data stream into frames and assigns different time slots to forward and reverse transmissions, thereby allowing both types of transmissions to share the same transmission medium.

In one embodiment, a frequency converter (FC) converts from 3GPP frequency bands (which include any of the bands described by 3GPP such as in Tables 1 and 2) to bands to be transported across HFC networks. In other embodiments, the system may include multiple frequency converters (FCs). When TDD is used, the FC is time switched between transmit and receive so that during transmission the FC is converting from 3GPP band to cable band and during receiving the FC is converting from cable band to 3GPP band. The time switching is performed in accordance with 3GPP 5G specification. For example, a frequency converter (FC) converts signals from 3GPP frequency bands, such as the n78 band in FR1 (3300-3800 MHZ), to specific bands within the HFC spectrum, such as 108-684 MHz, which is commonly used for full duplex (FDX) operations in cable networks. For instance, a 100 MHz channel in the n78 band may be mapped to a 100 MHz channel in the 200-300 MHz range of the HFC spectrum. In some embodiments, the FC is exactly synchronized in time. The FC may implement multiple strategies to achieve the exact synchronization in time. If the FC is integrated in a remote radio unit (RRU) then the synchronization can be done with internal synchronization. However, in embodiments where the FC is separate from the RRU and resides in the cable network, then signal detectors in each direction are inserted into the system. In some further embodiments, the FC is passive and does not require synchronization. In these passive embodiments, the FC automatically receives the frequencies and passively converts them.

In passive embodiments, the frequency converter (e.g., FC 130, FC 235, FC 160, or FC 255) employs a passive mixing network to shift each incoming 3GPP uplink and downlink band into the corresponding HFC spectrum without the need for active timing circuitry. This passive approach leverages frequency mixing to perform both up-conversion and down-conversion, imposing only 1-3 dB of insertion loss, which is critical for maintaining signal integrity. However, passive converters may have fixed frequency mappings, limiting flexibility compared to active, synchronized converters. The converter's passive mixing network performs both up-conversion and down-conversion with minimal insertion loss to preserve the link budget. Maintaining such minimal loss ensures that the downstream low-noise amplifier and the upstream pre-amplifier stages continue to operate with a high signal-to-noise ratio.

In another embodiment, the frequency converter (FC) directly converts baseband in-phase and quadrature (I-Q) signals, which represent the raw data streams before modulation, to specific frequencies within the HFC spectrum. This conversion bypasses the intermediate 3GPP frequency bands, allowing for more direct and efficient transmission over the cable network. Similar considerations to the above embodiment are required. These described embodiments apply to the architectures shown below. In addition, the FC performs the same functions in both directions.

The systems and methods described herein enable a transition from time division duplex (TDD) to full duplex (FDX) operations. While TDD alternates between upstream and downstream transmissions in time slots, FDX allows simultaneous bi-directional communication on the same frequency band. The system supports both modes, with TDD serving as a fallback to manage interference in FDX operations, ensuring reliable performance in various network conditions. In one embodiment, the system uses 5G TDD to give flexibility for both asymmetric and symmetric traffic. In some embodiments, asymmetric traffic may be for 12 Gbps (bits per second), where this is divided into 10 Gbps downstream and 2 Gbps upstream or 8 Gbps downstream and 4 Gbps upstream, for example. In other embodiments, symmetric traffic may be for 12 Gbps with 6 Gbps downstream and 6 Gbps upstream. In some embodiments, existing amplifiers work with the systems and methods described herein.

Full duplex (FDX) amplifiers are designed to boost both downstream (DS) and upstream (US) RF signal levels simultaneously, extending the coverage of the network node. Unlike conventional amplifiers, which typically handle DS and US in separate frequency bands, FDX amplifiers support bi-directional traffic in the same frequency band (e.g., 108-684 MHZ), enabling higher data throughput. However, this introduces challenges such as echo interference, which is mitigated through advanced echo cancellation (EC) techniques. The prefix ‘FDX’ means the amplifier supports FDX operation in FDX band 108 MHZ-684 MHz. To support FDX operation, the FDX amplifier needs to implement echo cancellation (EC) function and adopt a new architecture to accommodate this new EC function.

FDX operation inherently introduces co-channel interference, or echoes, where transmitted signals leak into the receiver path. To counteract this, FDX amplifiers implement echo cancellation (EC) on both input and output ports. The EC system must achieve sufficient echo suppression, typically 30-50 dB, to ensure that the net loop gain is less than zero, preventing self-oscillation and maintaining a high modulation error ratio (MER) for the received signal. The EC on the input port suppresses the echo of US transmitted signal on DS receiver, and the EC on the output port suppresses the echo of DS transmitted signal on US receiver. FDX amplifier hardware/system architecture needs to accommodate this new EC functions.

An FDX amplifier boosts both downstream (DS) and upstream (US) RF signal levels across the entire spectrum. For legacy frequency bands (e.g., US: 5-85 MHZ, DS: 684-1218 MHz), the amplifier operates similarly to conventional amplifiers. However, in the FDX band (108-684 MHZ), where DS and US signals overlap, the amplifier employs echo cancellation (EC) to manage interference and ensure signal integrity. For legacy spectrum (US 5 MHz-85 MHz, DS 684 MHz-1218 MHz), FDX amplifier operates the same way as the conventional amplifier. However, for the signals in the FDX band (108 MHZ-684 MHz) where DS and US RF signals overlap, FDX amplifier needs to implement EC. The EC needs be implemented on both input and output ports, sitting in front of the receivers. EC requires the reference signal to generate the cancelling signal. The reference signals are the transmitted signals coupled from the transmitters.

The primary design challenge for FDX amplifiers lies in achieving adequate echo cancellation (EC). The required suppression depends on the transmitted signal's power level and the expected received signal strength. For instance, if the transmitted signal is at +30 dBmV and the desired received signal is at −10 dBmV. In this instance, the EC must suppress the echo by at least 40 dB to ensure the echo does not overpower the received signal. As the DS and US signals overlap in FDX band 108 MHZ-684 MHZ, DS and US signals in FDX band have a closed loop amplification within FDX amplifier, the EC needs to provide sufficient echo suppression to ensure the net loop gain is less than zero to prevent the FDX amplifier from self-oscillation. Moreover, the echoes need be sufficiently suppressed below the desired received signal level to ensure good MER (modulation error ratio) for the received signal. The exact echo suppression required largely depends on the power level of the transmitted signal (echo power coupled to the receiver is linearly proportional to the power level of the transmitted signal) and the level of the desired signal that is expected to be received at the receiver, which will be examined in the following sections.

The required echo suppression can be calculated based on the transmitted power, the coupling factor, and the desired received signal level. For example, if the transmitted power is Pₜₓ, the coupling factor is C, and the desired received signal is Pᵣₓ, the required suppression S is given by S=Pₜₓ+C-Pᵣₓ+margin, where margin accounts for MER requirements. Typically, a margin of 10-20 dB is used to ensure high signal quality. In the example embodiment, the FDX amplifier RF specification should match with the legacy's, so when the FDX operation is enabled and the legacy amplifier is swapped out with FDX amplifier, the system link budget remains the same.

In one embodiment, the system utilizes 5G FDX technology to achieve symmetric traffic rates of up to 24 Gbps (12 Gbps downstream and 12 Gbps upstream) by leveraging the full duplex capabilities of the FDX amplifiers and the efficient frequency mapping provided by the frequency converters. This is particularly effective in scenarios where the HFC network has been upgraded to support higher frequency bands, such as 1.2 GHz or beyond. In some of these embodiments, the 5G FDX system co-exists with TDD. These 5G FDX systems allow for using TDD as a fallback to manage interference.

In addition to TDD and FDX, the system also supports frequency-division duplex (FDD) operation, where upstream and downstream signals are transmitted simultaneously in separate frequency bands. This contrasts with TDD, which alternates in time, and FDX, which uses the same band for both directions. In FDD mode, the system employs echo cancellation to suppress co-channel interference, ensuring continuous, high-quality transmission. A similar two-port echo-cancellation architecture described for FDX/TDD amplifiers (e.g., amplifier 145, 240, 340 or 435) applies in FDD mode to suppress co-channel interference. In FDD, uplink and downlink signals are continuous in their respective bands instead of time-switched into slots. An input-port echo canceller taps the downstream transmit signal and subtracts its echo from the continuous upstream receive path. An output-port echo canceller taps the upstream transmit signal and subtracts its echo from the continuous downstream receive path. By running both input-port and output-port cancellation persistently, the system maintains high modulation error ratios and prevents self-oscillation even under continuous upstream/downstream traffic.

Adapting wireless equipment, originally designed for over-the-air transmission, are modified for a wired HFC environment. These include replacing the wireless physical interface with coaxial or fiber connectors, adjusting the duplexing scheme to account for the wired medium's characteristics, and ensuring synchronization aligns with the cable network's timing requirements. Key aspects that need modification include, but are not limited to: the physical interface, duplexing and multiplexing schemes, and synchronization. The physical interface is to be replaced or modified with wired connectors suitable for the physical infrastructure of a wired network. The duplexing and multiplexing scheme was original designed for a wireless application. Synchronization needs to be modified and aligned with requirements of a wired network. For example, the 5G RAN equipment (BBU 120 and RRU 125), originally designed for over-the-air wireless operation, is used for wired HFC connectivity by replacing its wireless antenna ports with coaxial or fiber connectors.

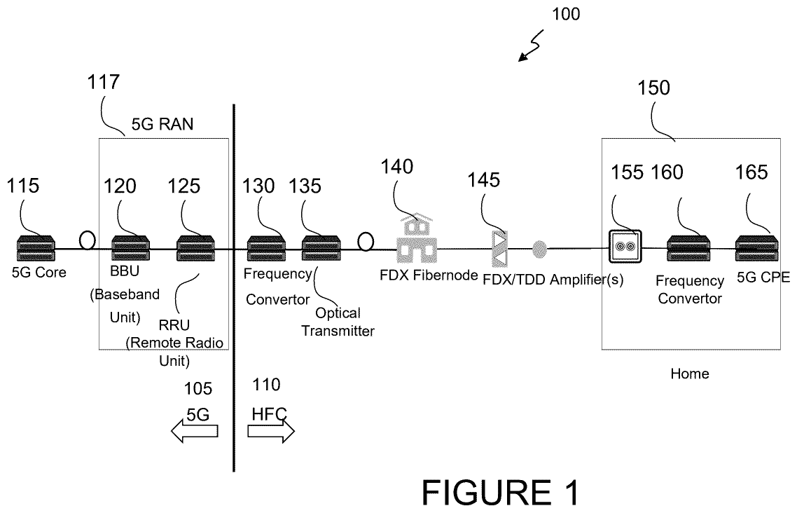

FIG. 1 illustrates a block diagram of System 100, which represents the first architecture for transmitting 5G signals over a hybrid fiber-coaxial (HFC) network. In this system, the 5G signal originates from the 5G Core system 115, is processed by the Baseband Unit (BBU) 120, and then passed to the Remote Radio Unit (RRU) 125, which outputs an RF signal. This RF signal is then converted by the Frequency Converter (FC) 130 to frequencies compatible with the HFC network. The converted signal is modulated onto the fiber by the Optical Transmitter 135, transmitted to the FDX fibernode 140, and then amplified by FDX/TDD amplifiers 145 before reaching the subscriber's home 150.

System 100 is divided into two primary segments: the 5G side 105, which includes the 5G Core system 115, BBU 120, and RRU 125, and the HFC side 110, which encompasses the frequency converter (FC) 130, optical transmitter 135, FDX fibernode 140, and the coaxial cable network leading to the subscriber's home 150. The frequency converter (FC) 130 serves as the interface between these two sides, translating 5G wireless frequencies to HFC-compatible frequencies. In the example embodiment, a 5G signal is provided via a 5G Core system 115, which may be a switching and/or routing system. The Baseband Unit (BBU) 120 is responsible for digital signal processing, including encoding, modulation, and managing the 5G protocol stack. The Remote Radio Unit (RRU) 125, on the other hand, handles the analog radio frequency (RF) aspects, such as up-converting the baseband signal to the desired 3GPP frequency band and amplifying it for transmission. The 5G Core 115 is a centralized piece of equipment. Furthermore, a plurality of subscribers connect to the 5G Core 115. The 5G signal comes to the 5G RAN (radio access network) 117 that contains a baseband unit (BBU) 120 and a remote radio unit (RRU) 125. In the example embodiment, the BBU 120 handles signal processing, while the RRU 125 handles the radio frequency (RF) side. In some embodiments, the BBU 120 and the RRU 125 are combined. In other embodiments, the BBU 120 and the RRU 25 are separate, as shown here. In the example embodiment, the RRU 125 outputs an RF signal.

In the example embodiment, RRU 125 outputs the signal, which is received by a frequency converter (FC) 130. For example, the RRU 125 outputs an RF signal in a 3GPP frequency band, such as the n78 band (3300-3800 MHZ), which is then received by the frequency converter (FC) 130 for conversion to HFC-compatible frequencies. The FC 130 converts the received signal to one or more frequencies that the cable side 110 can carry, as described in more detail herein. In the example embodiment, the optical transmitter 135 receives the cable signal from the FC 130. The optical transmitter 135 modulates the 5G signal onto fiber. In some embodiments, the FC 130 and the optical transmitter 135 are combined into one device. In other embodiments, the FC 130 and the RRU 125 are combined into one device.

In one embodiment, the FC 130 converts from 3GPP frequency bands (which include any of the bands described by 3GPP such as in Tables 1 and 2) to bands to be transported across HFC networks. When TDD is used, the FC 130 is time switched between transmit and receive so that during transmission the FC 130 is converting from 3GPP band to cable band and during receiving the FC 130 is converting from cable band to 3GPP band. The time switching is performed in accordance with 3GPP 5G specification. In some embodiments, the FC 130 is exactly synchronized in time. There are multiple different ways to achieve exact synchronization in time. If the FC 130 is integrated in the RRU 125 then the synchronization can be done with internal synchronization. However, if the FC 130 is separate from the RRU 125 and resides in the cable network 110, then signal detectors in each direction are inserted into the system. In some further embodiments, the FC 130 is passive and does not require synchronization. In these passive embodiments, the FC 130 automatically receives the frequencies and passively converts them.

In another embodiment, the FC 130 converts from base band I-Q channels to cable frequencies without using 3GPP bands. For example, the frequency converter (FC) 130 directly converts baseband I-Q signals from the BBU to specific frequencies within the HFC spectrum, bypassing the intermediate 3GPP frequency bands. This direct conversion reduces complexity and potential signal degradation, offering a more efficient path for 5G signal transmission over cable networks. Similar considerations to the above embodiment are required. In addition, the FC 130 performs the same functions in both directions, converting from 5G to cable and converting from cable to 5G in the other direction.

In some embodiments, the system 100 includes one or more FDX fibernodes 140 that receives the analog optical signal and translates/converts that analog optical signal into an electrical signal. For example, the FDX fibernode 140 receives the analog optical signal from the optical transmitter 135 and converting it into an electrical RF signal. This RF signal is then distributed through the coaxial cable network to the subscriber's home. In FDX-capable fibernodes, the device also supports full duplex operations, allowing simultaneous upstream and downstream traffic in the FDX band. In some embodiments, the system 100 uses analog fiber transmission. In these embodiments, the signal may depend on the specifications of the fibernodes 140. In other embodiments, the system 100 uses digital signal formats.

In the example embodiment, the cable side 110 includes a plurality of FDX/TDD amplifiers 145 that are configured to reamplify the signal to avoid signal deterioration in the HFC network. These amplifiers 145 are bi-directional in all bands and amplify signals in both directions across all bands for FDX (full duplex) and/or TDD (time division duplex) in the HFC network. The amplifiers 145 are a key aspect of the cable network side 110 and allow for greater extension of the reach of the signal. In some embodiments, existing amplifiers work with the systems and methods described herein. In other embodiments, amplifiers are modified to work with the 5G FDX and/or TDD systems. Depending on the needs of the system, the bi-directional traffic may be asymmetric or symmetric using the 5G TDD and FDX technologies. For example, on the cable side 110, the system includes multiple FDX/TDD amplifiers 145, which are essential for maintaining signal strength and quality over long distances in the HFC network. These amplifiers are bi-directional, capable of amplifying both downstream and upstream signals across all frequency bands, including the FDX band (108-684 MHZ) for full duplex operations and time-slotted bands for TDD operations. By reamplifying the signal, these amplifiers prevent signal deterioration due to attenuation in the coaxial cable.

The term ‘FDX/TDD amplifier’ refers to an amplifier that can operate in either full duplex (FDX) mode, time division duplex (TDD) mode, or both, depending on the network configuration. In FDX mode, the amplifier supports simultaneous bi-directional traffic in the same frequency band, while in TDD mode, it alternates between amplifying downstream and upstream signals in different time slots. Some embodiments include hybrid amplifiers that can dynamically switch between FDX and TDD based on network demands or interference conditions.

Furthermore, FDX/TDD amplifiers 145 amplify bi-directional full duplex traffic that may simultaneously use frequency spectrum in both the upstream (US) and downstream (DS) directions. However, with bi-directional full duplex traffic, interferences and echoes may occur in conventional amplifiers. Accordingly, some FDX/TDD amplifiers 145 also provide interference and echo cancellation on both the US and DS directions. FDX/TDD amplifiers 145 may be chained serially to transport signals with high levels of signal quality and strength. For example, FDX/TDD amplifiers 145 are designed to amplify bi-directional full duplex traffic, allowing simultaneous use of the same frequency spectrum for both upstream (US) and downstream (DS) directions. To manage the resulting interference and echoes, these amplifiers incorporate advanced echo cancellation (EC) systems that suppress unwanted signals, ensuring that the amplified output remains clean and free from self-oscillation.

In some embodiments, the FDX/TDD amplifier 145, when operating in TDD mode, is time switched between transmit and receive so that during transmission the FDX/TDD amplifier 145 is amplifying the downstream signal and during receiving the FDX/TDD amplifier 145 is amplifying the upstream signal. The time switching is performed in accordance with 3GPP 5G specification by a control mechanism on the FDX/TDD amplifier 145. In some embodiments, the FDX/TDD amplifiers 145 are exactly synchronized in time by the control mechanism using a synchronization signal. In another embodiment, no synchronization signal is needed and instead the control mechanism includes a signal detector that controls the time switching in a way that when a signal is detected in the transmission stream, then the transmission amplification will start and continue until no signal is detected. For the receiving stream, the control mechanism includes a separate signal detector can be used to form the same process. In another embodiment, the receiving amplification can start controlled by when there is no signal in the transmission stream. For example, when operating in TDD mode, the FDX/TDD amplifier 145 is time-switched by the control mechanism between amplifying downstream (transmit) and upstream (receive) signals. This switching is synchronized across the network by the control mechanism to ensure that all amplifiers and devices are aligned in their transmission and reception phases, typically following the timing specifications outlined in the 3GPP 5G standard. In various embodiments, the control mechanism synchronized with the upstream signal and the downstream signal with the internal timing mechanisms or the external signal detectors.

In other embodiments, the FDX/TDD amplifiers 145 are not time switched. In these embodiments, the FDX/TDD amplifiers 145 receive, amplify, and pass through signals received in both directions simultaneously. In one embodiment, the FDX/TDD amplifier 145 operates with a full EC (echo canceller) both in FDX and TDD mode. In another embodiment, the EC is modified so that when operating in TDD mode both the uplink reference signal and the downlink reference signal inside the EC are disconnected. This can either be done permanently when operating as a TDD amplifier. Alternatively, a signal detector similar to that described above can detect that a TDD signal is present and control the disconnection of the reference signals. For example, in FDX mode, the FDX/TDD amplifiers 145 are not time switched, as they are designed to handle simultaneous bi-directional traffic. In this embodiment, the amplifiers continuously amplify both downstream and upstream signals, relying on echo cancellation to mitigate interference between the two directions.

In some embodiments, there may be multiple amplifiers 145 before the signal reaches the subscriber's home 150. The signal is received in the home 150 via one or more outlets 155. From the outlet 155, the signal is received by a frequency converter (FC 160) that converts the signal back to 5G signals before transmitting the 5G signal per wire to the customer premises equipment (CPE) 165. In some further embodiments, part of the 5G licensed spectrum will be emitted by the 5G CPE 165 to serve as a Pico cell. For example, the signal may pass through three to four FDX/TDD amplifiers 145 before reaching the subscriber's home 150. Each amplifier boosts the signal to compensate for attenuation in the coaxial cable, ensuring that the signal maintains sufficient strength and quality for reliable 5G transmission.

In operation, the system 100 includes a 5G side and a HFC side 110. A radio signal originates at 5G Core system 115, is processed by Baseband Unit 120, and forwarded to Remote Radio Unit 125, which outputs an RF signal. The RF signal from the Remote Radio Unit 125 is provided to Frequency Converter 130, where TDD or FDD conversion maps the 3GPP bands into cable-frequency bands on the HFC spectrum. The converted signal is passed to Optical Transmitter 135 and carried over fiber to FDX fibernode 140. FDX/TDD Amplifiers 145 along the HFC path boost the signal before it reaches Subscriber's Home 150. From Outlet 155, Frequency Converter 160 reconverts the signal into 5G bands for delivery to Customer Premises Equipment 165. At the subscriber's home, the signal from the outlet 155 is received by a frequency converter (FC 160), which converts the HFC-compatible frequencies back to the original 5G RF signals in the appropriate 3GPP bands (e.g., n78 band at 3300-3800 MHz). This converted RF signal is then transmitted via a wired connection to the customer premises equipment (CPE) 165, which may further process or distribute the signal within the home.

The system 100 and thus all its components work in both directions transmitting from the 5G network 105 to the cable network 110 and transmitting from the cable network 110 to the 5G network. In the example embodiment, the system 100 is designed to operate bi-directionally, supporting both downstream transmission from the 5G network 105 to the cable network 110 and upstream transmission from the cable network 110 back to the 5G network 105. In both directions, the frequency converters (e.g., FC 130 and FC 160) perform the frequency translations, and the FDX/TDD amplifiers 145 amplify the signals to maintain quality.

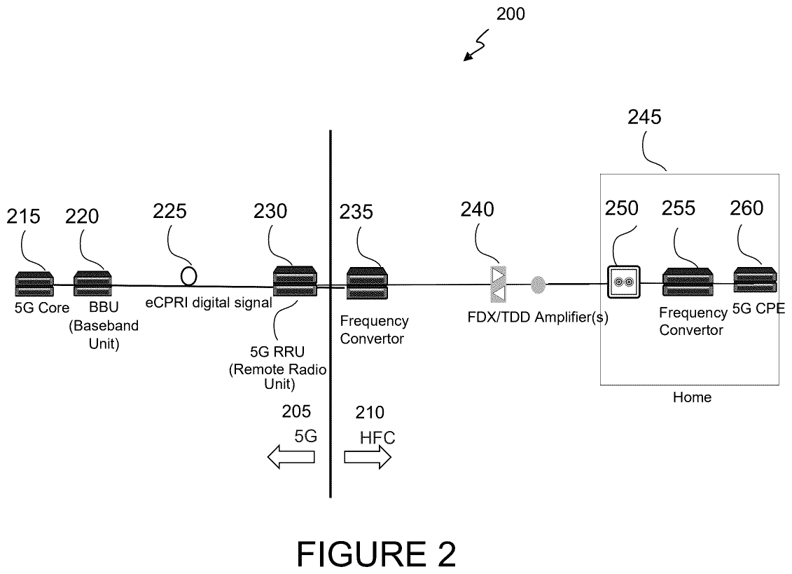

FIG. 2 illustrates a block diagram for a second architecture of a system 200 for 5G over coaxial cable, in accordance with at least one embodiment.

In system 200, there is a 5G side 205 of the system 200 and an HFC (Hybrid Fiber-Coaxial) side 210 (or cable side 210) of the system 200. In the example embodiment, a 5G signal is provided via a 5G Core system 215, which may be a switching and/or routing system. In the example embodiment, the 5G Core 215 is a centralized piece of equipment. Furthermore, a plurality of subscribers are connected to the 5G Core 215. The 5G signal comes to a baseband unit (BBU) 220. The BBU 220 handles signal processing and then transmits the signal over optical fiber 225 to a remote radio unit (RRU) 230. In one example embodiment, the signal between the BBU 220 and the RRU 230 is a digital eCPRI (enhanced common public radio interface) signal. One having skill in the art would understand that these systems and methods would also work with other types of signals and/or protocols.

In the example embodiment, RRU 230 outputs the signal, which is received by a frequency converter (FC) 235. The FC 235 converts the received signal to one or more frequencies that the cable side 210 can carry, as described in more detail herein. In some embodiments, the FC 235 and the RRU 230 are combined into one device.

In one embodiment, the FC 235 converts from 3GPP frequency bands (which include any of the bands described by 3GPP such as in Tables 1 and 2) to bands to be transported across HFC networks. When TDD is used, the FC 235 is time switched between transmit and receive so that during Tx the FC 235 is converting from 3GPP band to cable band and during Rx the FC 235 is converting from cable band to 3GPP band. The time switching is performed in accordance with 3GPP 5G specification. In some embodiments, the FC 235 is exactly synchronized in time. There are multiple different ways to achieve exact synchronization in time. If the FC 235 is integrated in the RRU 230 then the synchronization can be done with internal synchronization. However, if the FC 235 is separate from the RRU 230 and resides in the cable network 210, then signal detectors in each direction are inserted into the system. In some further embodiments, the FC 235 is passive and does not require synchronization. In these passive embodiments, the FC 235 automatically receives the frequencies and passively converts them.

In another embodiment, the FC 235 converts from base band I-Q channels to cable frequencies without using 3GPP bands. Similar considerations to the above embodiment are required. In addition, the FC 235 performs the same functions in both directions, converting from 5G to cable and converting from cable to 5G in the other direction.

As used herein, an FDX/TDD amplifier means an amplifier that can be FDX and/or TDD which includes for example a hybrid amplifier performing both FDX and TDD, a standalone FDX amplifier, a standalone TDD amplifier. In all cases operating in any cable spectrum.

In the example embodiment, the cable side 210 includes a plurality of FDX/TDD amplifiers 240 that are configured to reamplify the signal to avoid signal deterioration in the HFC network. These amplifiers 240 are bi-directional in all bands and amplify signals in both directions across all bands for FDX (fully duplex) and/or TDD (time division duplex) in the HFC network. The amplifiers 240 are a key aspect of the cable network side 210 and allow for greater extension of the reach of the signal. In some embodiments, existing amplifiers work with the systems and methods described herein. In other embodiments, amplifiers are modified to work with the 5G FDX and/or TDD systems. Depending on the needs of the system, the bi-directional traffic may be asymmetric or symmetric using the 5G TDD and FDX technologies.

Furthermore, FDX/TDD amplifiers 240 amplify bi-directional full duplex traffic that may simultaneously use frequency spectrum in both the upstream (US) and downstream (DS) directions. However, with bi-directional full duplex traffic, interferences and echoes may occur in conventional amplifiers. Accordingly, some FDX/TDD amplifiers 240 also provide interference and echo cancellation on both the US and DS directions. FDX/TDD amplifiers 240 may be chained serially to transport signals with high levels of signal quality and strength.

In some embodiments, the FDX/TDD amplifier 240, when operating in TDD mode, is time switched between transmit and receive so that during Tx the FDX/TDD amplifier 240 is amplifying the downstream signal and during Rx the FDX/TDD amplifier 240 is amplifying the upstream signal. The time switching is performed in accordance with 3GPP 5G specification. In some embodiments, the FDX/TDD amplifiers 240 are exactly synchronized in time by the use of a synchronization signal. In another embodiment, no synchronization signal is needed and instead a signal detector controls the time switching in a way that when a signal is detected in the TX stream, then the TX amplification will start and continue until no signal is detected. For the RX stream, a separate signal detector can be used to form the same process. In another embodiment, the RX amplification can start controlled by when there is no signal in the TX stream.

In other embodiments, the FDX/TDD amplifiers 240 are not time switched. In these embodiments, the FDX/TDD amplifiers 240 receive, amplify, and pass through signals received in both directions simultaneously. In one embodiment, the FDX/TDD amplifier 240 operates with a full EC (echo canceller) both in FDX and TDD mode. In another embodiment, the EC is modified so that when operating in TDD mode both the uplink reference signal and the downlink reference signal inside the EC are disconnected. This can either be done permanently when operating as a TDD amplifier. Alternatively, a signal detector similar to that described above can detect that a TDD signal is present and control the disconnection of the reference signals.

In some embodiments, there may be multiple amplifiers 240 before the signal reaches the subscriber's home 245. The signal is received in the home 245 via one or more outlets 250. From the outlet 250, the signal is received by a frequency converter (FC 255) that converts the signal back to 5G signals before the transmitting the 5G signal per wire to the customer premises equipment (CPE) 260. In some further embodiments, part of the 5G licensed spectrum will be emitted by the 5G CPE 260 to serve as a Pico cell.

In operation, system 200 includes a 5G side 205 and HFC side 210. A radio signal originates at 5G Core system 215, is processed by Baseband Unit 220, and transmitted over Optical Fiber 225 to the Remote Radio Unit 230. The RRU 230 outputs an RF signal to Frequency Converter 235, where TDD or FDD conversion maps the signal into cable-frequency bands. FDX/TDD Amplifiers 240 along the HFC path maintain signal integrity as the signal propagates toward Subscriber's Home 245. From Outlet 250, Frequency Converter 255 reconverts the signal into 5G bands for handoff to Customer Premises Equipment 260.

The system 200 and thus all of its components work in both directions transmitting from the 5G network 205 to the cable network 210 and transmitting from the cable network 210 to the 5G network. The FCs 235 and 255 work in both directions converting frequencies based on the direction of transmission.

In some further embodiments, the RRU 125 or 230 supports MIMO (multiple input, multiple output). In these embodiments, instead of having the RRU 125 or 230 output one RF signal, the RRU 125 or 230 outputs multiple RF signals that the frequency converters 130 or 235 convert to different frequencies in the cable band. This allows the RRU 125 or 230 to act like multiple antennas, simultaneously.

In additional embodiments, a hybrid architecture of system 100 (shown in FIG. 1) and system 200 may be used to allow the choice between cable and radio for the last mile.

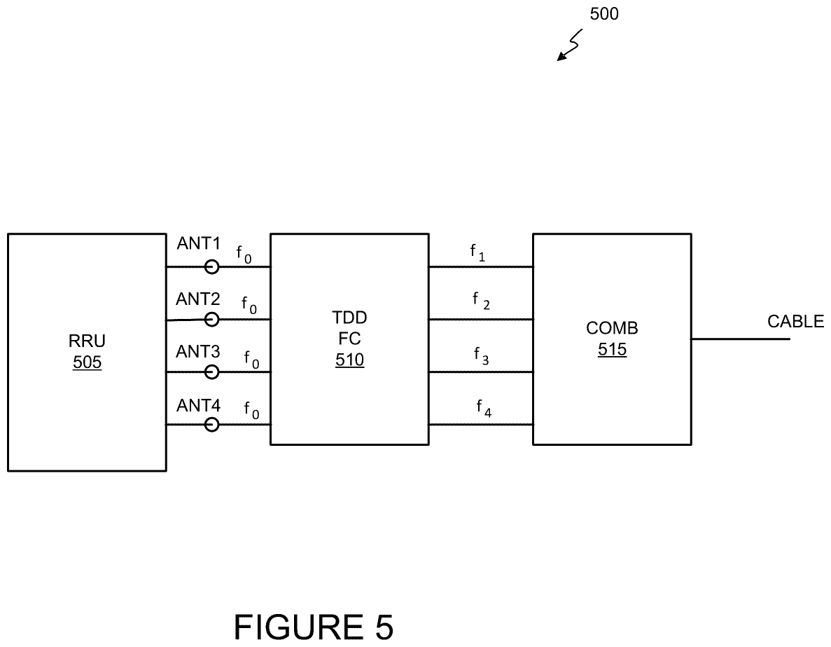

MIMO currently exists in the wireless world by having N Multiple Input Multiple Output antennas connected to the same RRU 125 & 230 equipment. This provides an increased data rate by a factor of N. To use MIMO over Cable, the FCs 130, 160, 235, & 255 may be used in some embodiments as needed. MIMO is further described in FIG. 5.

In MIMO embodiments, a Remote Radio Unit (e.g., RRU 125 in System 100 or RRU 230 in System 200) outputs N parallel RF streams, all occupying the same 3GPP channel. Each stream is routed into its own Frequency Converter such as FC 130 at the headend or FC 160/255 at the subscriber premises where it is translated into a distinct cable-frequency band channel f₁ through fₙ. To prevent inter-channel interference, minimal guard-bands of just a few megahertz separate adjacent channels, preserving spectral isolation and signal integrity. The resulting N cable-frequency channels are then merged by a combiner network (e.g., Combiner 515 in System 500) into a single HFC feed. At the far end, each channel is reconverted by its corresponding FC and delivered to the Customer Premises Equipment (e.g., CPE 165, CPE 260, CPE 355, or CPE 450) for standard MIMO demultiplexing. For example, the Remote Radio Unit (e.g., RRU 125 or RRU 230) outputs N parallel RF streams, each corresponding to a different antenna and occupying the same 3GPP frequency channel. These streams are then individually converted by the frequency converter to distinct frequency channels within the HFC spectrum (e.g., f₁, f₂, . . . , f_{N}), allowing them to be transmitted simultaneously over the cable network without interference.

In embodiment a, it is converting a single frequency channel of say 100 MHz in a 3GPP band to N frequency channels of the same bandwidth (100 MHZ) in the cable band. This is done by converting N antenna signals of the same frequency in a 3GPP band to N different frequency channels in the cable band. In the CPE, the same operation is reversed. Downlink and uplink can have different MIMO sizes for example 4×4 MIMO in downlink and 2×2 MIMO in uplink.

In embodiment b, the function is the same as explained in a. However, the I-Q channels are then the N I-Q channels of the corresponding antenna signals.

In a further embodiment the FCs 130, 160, 235, & 255 can be used with a single frequency mixer converting one channel of 100 MHz to N channels of 100 MHz.

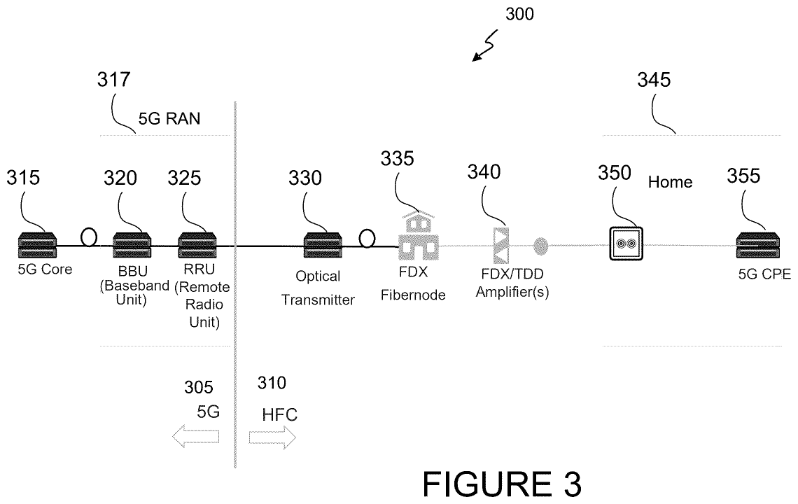

FIG. 3 illustrates a block diagram for a third architecture of a system 300 for 5G over coaxial cable, in accordance with at least one embodiment.

In system 300 there is a 5G side 305 of the system 300 and an HFC (Hybrid Fiber-Coaxial) side 310 (or cable side 310) of the system 300. In the example embodiment, a 5G signal is provided via a 5G Core system 315, which may be a switching and/or routing system. In the example embodiment, the 5G Core 315 is a centralized piece of equipment. Furthermore, a plurality of subscribers are connected to the 5G Core 315. The 5G signal comes to the 5G RAN (radio access network) 317 that contains a baseband unit (BBU) 320 and a remote radio unit (RRU) 325. In the example embodiment, the BBU 320 handles signal processing, while the RRU 325 handles the radio frequency (RF) side. In some embodiments, the BBU 320 and the RRU 325 are combined. In other embodiments, the BBU 320 and the RRU 325 are separate, as shown here. In the example embodiment, the RRU 325 outputs an RF QAM signal.

In the example embodiment, RRU 325 outputs the signal in one or more frequencies that the cable side 310 can carry, as described in more detail herein. In the example embodiment, the optical transmitter 330 receives the 5G signal from the RRU 325. The optical transmitter 330 modulates the 5G signal onto fiber.

In some embodiments, the system 300 includes one or more FDX fibernodes 335 that receives the analog optical signal and translates/converts that analog optical signal into an electrical signal. In some embodiments, the system 300 uses analog fiber transmission. In these embodiments, the signal may depend on the specifications of the fibernodes 335. In other embodiments, the system 300 uses digital signal formats.

As used herein, an FDX/TDD amplifier means an amplifier that can be FDX and/or TDD which includes for example a hybrid amplifier performing both FDX and TDD, a standalone FDX amplifier, a standalone TDD amplifier. In all cases operating in any cable spectrum.

In the example embodiment, the cable side 310 includes a plurality of FDX/TDD amplifiers 340 that are configured to reamplify the signal to avoid signal deterioration in the HFC network. These amplifiers 340 are bi-directional in all bands and amplify signals in both directions across all bands for FDX (full duplex) and/or TDD (time division duplex) in the HFC network. The amplifiers 340 are a key aspect of the cable network side and allow for greater extension of the reach of the signal. In some embodiments, existing amplifiers work with the systems and methods described herein. In other embodiments, amplifiers are modified to work with the 5G FDX and/or TDD systems. Depending on the needs of the system, the bi-directional traffic may be asymmetric or symmetric using the 5G TDD and FDX technologies.

Furthermore, FDX/TDD amplifiers 340 amplify bi-directional full duplex traffic that may simultaneously use frequency spectrum in both the upstream (US) and downstream (DS) directions. However, with bi-directional full duplex traffic, interferences and echoes may occur in conventional amplifiers. Accordingly, some FDX/TDD amplifiers 340 also provide interference and echo cancellation on both the US and DS directions. FDX/TDD amplifiers 340 may be chained serially to transport signals with high levels of signal quality and strength.

In some embodiments, the FDX/TDD amplifier 340, when operating in TDD mode, is time switched between transmit and receive so that during transmission the FDX/TDD amplifier 340 is amplifying the downstream signal and during receiving the FDX/TDD amplifier 340 is amplifying the upstream signal. The time switching is performed in accordance with 3GPP 5G specification. In some embodiments, the FDX/TDD amplifiers 340 are exactly synchronized in time by the use of a synchronization signal. In another embodiment, no synchronization signal is needed and instead a signal detector controls the time switching in a way that when a signal is detected in the transmission stream, then the transmission amplification will start and continue until no signal is detected. For the receiving stream, a separate signal detector can be used to form the same process. In another embodiment, the receiving amplification can start controlled by when there is no signal in the TX stream.

In other embodiments, the FDX/TDD amplifiers 340 are not time switched. In these embodiments, the FDX/TDD amplifiers 340 receive, amplify, and pass through signals received in both directions simultaneously. In one embodiment, the FDX/TDD amplifier 340 operates with a full EC (echo canceller) both in FDX and TDD mode. In another embodiment, the EC is modified so that when operating in TDD mode both the uplink reference signal and the downlink reference signal inside the EC are disconnected. This can either be done permanently when operating as a TDD amplifier. Alternatively, a signal detector similar to that described above can detect that a TDD signal is present and control the disconnection of the reference signals.

In operation system 300 includes a 5G side 305 and HFC side 310. A radio signal originates at 5G Core system 315, is processed by Baseband Unit 320, and forwarded to Remote Radio Unit 325. RRU 325 outputs an RF QAM signal, which is modulated onto fiber by Optical Transmitter 330. The modulated signal is translated to electrical form by FDX fibernode 335 and boosted by FDX/TDD Amplifiers 340 along the HFC path. Upon reaching Subscriber's Home 345, the signal emerges from Outlet 350 and is received by Customer Premises Equipment 355, which reconverts it into native 5G bands for local use.

In some embodiments, there may be three to four amplifiers 340 before the signal reaches the subscriber's home 345. The signal is received in the home 345 via one or more outlets 350. From the outlet 350 the signal is transmitted to the customer premises equipment (CPE) 355.

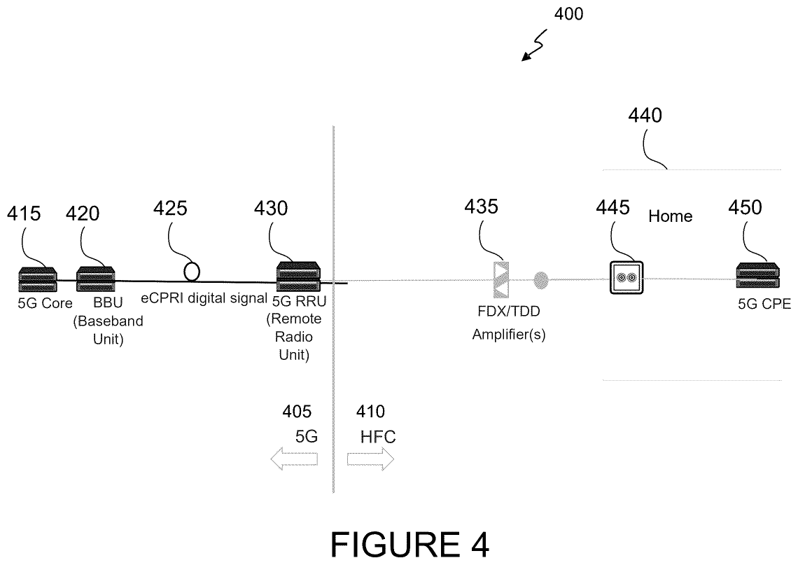

FIG. 4 illustrates a block diagram for a fourth architecture of a system 400 for 5G over coaxial cable, in accordance with at least one embodiment.

In system 400 there is a 5G side 405 of the system 400 and an HFC (Hybrid Fiber-Coaxial) side 410 (or cable side 410) of the system 400. In the example embodiment, a 5G signal is provided via a 5G Core system 415, which may be a switching and/or routing system. In the example embodiment, the 5G Core 415 is a centralized piece of equipment. Furthermore, a plurality of subscribers are connected to the 5G Core 415. The 5G signal comes to a baseband unit (BBU) 420. The BBU 420 handles signal processing and then transmits the signal over optical fiber 425 to a remote radio unit (RRU) 430. The signal between the BBU 420 and the RRU 430 is a digital eCPRI (enhanced common public radio interface) signal. One having skill in the art would understand that these systems and methods would also work with other types of signals and/or protocols.

In the example embodiment, RRU 430 outputs the signal in one or more frequencies that the cable side 410 can carry, as described in more detail herein.

As used herein, an FDX/TDD amplifier means an amplifier that can be FDX and/or TDD which includes for example a hybrid amplifier performing both FDX and TDD, a standalone FDX amplifier, a standalone TDD amplifier. In all cases operating in any cable spectrum.

In the example embodiment, the cable side 410 includes a plurality of FDX/TDD amplifiers 435 that are configured to reamplify the signal to avoid signal deterioration in the HFC network. These amplifiers 435 are bi-directional in all bands and amplify signals in both directions across all bands for FDX (full duplex) and/or TDD (time division duplex) in the HFC network. The amplifiers 435 are a key aspect of the cable network side and allow for greater extension of the reach of the signal. In some embodiments, existing amplifiers work with the systems and methods described herein. In other embodiments, amplifiers are modified to work with the 5G FDX and/or TDD systems. Depending on the needs of the system, the bi-directional traffic may be asymmetric or symmetric using the 5G TDD and FDX technologies.

Furthermore, FDX/TDD amplifiers 435 amplify bi-directional full duplex traffic that may simultaneously use frequency spectrum in both the upstream (US) and downstream (DS) directions. However, with bi-directional full duplex traffic, interferences and echoes may occur in conventional amplifiers. Accordingly, some FDX/TDD amplifiers 435 also provide interference and echo cancellation on both the US and DS directions. FDX/TDD amplifiers 435 may be chained serially to transport signals with high levels of signal quality and strength.

In some embodiments, the FDX/TDD amplifier 435, when operating in TDD mode, is time switched between transmit and receive so that during Tx the FDX/TDD amplifier 435 is amplifying the downstream signal and during Rx the FDX/TDD amplifier 435 is amplifying the upstream signal. The time switching is performed in accordance with 3GPP 5G specification. In some embodiments, the FDX/TDD amplifiers 435 are exactly synchronized in time by the use of a synchronization signal. In another embodiment, no synchronization signal is needed and instead a signal detector controls the time switching in a way that when a signal is detected in the TX stream, then the TX amplification will start and continue until no signal is detected. For the RX stream, a separate signal detector can be used to form the same process. In another embodiment, the RX amplification can start controlled by when there is no signal in the TX stream.

In other embodiments, the FDX/TDD amplifiers 435 are not time switched. In these embodiments, the FDX/TDD amplifiers 435 receive, amplify, and pass through signals received in both directions simultaneously. In one embodiment, the FDX/TDD amplifier 435 operates with a full EC (echo canceller) both in FDX and TDD mode. In another embodiment, the EC is modified so that when operating in TDD mode both the uplink reference signal and the downlink reference signal inside the EC are disconnected. This can either be done permanently when operating as a TDD amplifier. Alternatively, a signal detector similar to that described above can detect that a TDD signal is present and control the disconnection of the reference signals.

In some embodiments, there may be three to four amplifiers 435 before the signal reaches the subscriber's home 440. The signal is received in the home 440 via one or more outlets 445. From the outlet 445 the signal is transmitted to the customer premises equipment (CPE) 450.

In some further embodiments, the RRU 325 or 430 supports MIMO (multiple input, multiple output). In these embodiments, instead of having the RRU 325 or 430 output one RF signal, the RRU 325 or 430 outputs multiple RF signals at different frequencies in the cable band. This allows the RRU 325 or 430 to act like multiple antennas, simultaneously.

In operation, system 400 includes 5G side 405 and HFC side 410. A radio signal originates at 5G Core system 415, is processed by Baseband Unit 420, and transmitted over Optical Fiber 425 to Remote Radio Unit 430. RRU 430 outputs the signal in cable-frequency bands, which is reamplified by FDX/TDD Amplifiers 435 along the HFC path. Upon arriving at Subscriber's Home 440, the signal is accessed via Outlet 445 and provided to Customer Premises Equipment 450, which reconverts it into 5G bands for end-user equipment.

In additional embodiments, a hybrid architecture of system 300 (shown in FIG. 3) and system 400 may be used to allow the choice between cable and radio for the last mile.

Table 1 illustrates Frequency Range 1 (FR1) for the 3GPP frequency bands for 5G NR (5G New Radio). Table 1 includes sub-6 GHz frequency bands, some of which are traditionally used by previous standards, but has been extended to cover potential new spectrum offerings from 410 MHz to 7125 MHZ. Table 2 illustrates Frequency Range 2 (FR2), which includes 3GPP frequency bands from 24.25 GHZ to 71.0 GHZ.

TABLE 1

| | | | | Subset | | | Duplex | Channel |
|---|---|---|---|---|---|---|---|---|
| | Duplex | f | Common | of | Uplink | Downlink | spacing | bandwidths |
| Band | mode | (MHz) | name | band | (MHz) | (MHz) | (MHz) | (MHz) |
| n1 | FDD | 2100 | IMT | n65 | 1920- | 2110- | 190 | 5, 10, 15, |
| | | | | | 1980 | 2170 | | 20, 25, 30, |
| | | | | | | | | 40, 45, 50 |
| n2 | FDD | 1900 | PCS | n25 | 1850- | 1930- | 80 | 5, 10, 15, |
| | | | | | 1910 | 1990 | | 20, 25, 30, |
| | | | | | | | | 35, 40 |
| n3 | FDD | 1800 | DCS | | 1710- | 1805- | 95 | 5, 10, 15, |
| | | | | | 1785 | 1880 | | 20, 25, 30, |
| | | | | | | | | 35, 40, 45, |
| | | | | | | | | 50 |
| n5 | FDD | 850 | CLR | n26 | 824- | 869- | 45 | 5, 10, 15, |
| | | | | | 849 | 894 | | 20, 25 |
| n7 | FDD | 2600 | IMT-E | | 2500- | 2620- | 120 | 5, 10, 15, |
| | | | | | 2570 | 2690 | | 20, 25, 30, |
| | | | | | | | | 35, 40, 50 |
| n8 | FDD | 900 | Extended | | 880- | 925- | 45 | 5, 10, 15, |
| | | | GSM | | 915 | 960 | | 20, 25, 35 |
| n12 | FDD | 700 | Lower SMH | n85 | 699- | 729- | 30 | 5, 10, 15 |
| | | | | | 716 | 746 | | |
| n13 | FDD | 700 | Upper SMH | | 777- | 746- | −31 | 5, 10 |
| | | | | | 787 | 756 | | |
| n14 | FDD | 700 | Upper SMH | | 788- | 758- | −30 | 5, 10 |
| | | | | | 798 | 768 | | |
| n18 | FDD | 850 | Lower 800 | n26 | 815- | 860- | 45 | 5, 10, 15 |
| | | | (Japan) | | 830 | 875 | | |
| n20 | FDD | 800 | Digital | | 832- | 791- | −41 | 5, 10, 15, |
| | | | Dividend (EU) | | 862 | 821 | | 20 |
| n24 | FDD | 1600 | Upper L- | | 1626.5- | 1525- | −101.5 | 5, 10 |
| | | | band (US) | | 1660.5 | 1559 | | |
| n25 | FDD | 1900 | Extended PCS | | 1850- | 1930- | 80 | 5, 10, 15, |
| | | | | | 1915 | 1995 | | 20, 25, 30, |
| | | | | | | | | 35, 40, 45 |
| n26 | FDD | 850 | Extended CLR | | 814- | 859- | 45 | 3, 5, 10, |
| | | | | | 849 | 894 | | 15, 20, 25, |
| | | | | | | | | 30 |
| n28 | FDD | 700 | APT | | 703- | 758- | 55 | 3, 5, 10, |
| | | | | | 748 | 803 | | 15, 20, 25, |
| | | | | | | | | 30 |
| n29 | SDL | 700 | Lower SMH | | — | 717- | — | 5, 10 |
| | | | | | | 728 | | |
| n30 | FDD | 2300 | WCS | | 2305- | 2350- | 45 | 5, 10 |
| | | | | | 2315 | 2360 | | |
| n31 | FDD | 450 | NMT | | 452.5- | 462.5- | 10 | 3, 5 |
| | | | | | 457.5 | 467.5 | | |
| n34 | TDD | 2100 | IMT | | 2010- | | — | 5, 10, 15 |
| | | | | | 2025 | | | |
| n38 | TDD | 2600 | IMT-E | n41, | 2570- | | — | 5, 10, 15, |
| | | | | n90 | 2620 | | | 20, 25, 30, |
| | | | | | | | | 40 |
| n39 | TDD | 1900 | DCS-IMT | | 1880- | | — | 5, 10, 15, |
| | | | Gap | | 1920 | | | 20, 25, 30, |
| | | | | | | | | 35, 40 |
| n40 | TDD | 2300 | S-Band | | 2300- | | — | 5, 10, 15, |
| | | | | | 2400 | | | 20, 25, 30, |
| | | | | | | | | 40, 50, 60, |
| | | | | | | | | 70, 80, 90, |
| | | | | | | | | 100 |
| n41 | TDD | 2500 | BRS | | 2496- | | — | 5,10,15, |
| | | | | | 2690 | | | 20, 25, 30, |
| | | | | | | | | 35, 40, 45, |
| | | | | | | | | 50, 60, 70, |
| | | | | | | | | 80, 90, 100 |
| n46 | TDD | 5200 | U-NII-1-4 | | 5150- | | — | 10, 20, 40, |
| | | | | | 5925 | | | 60, 80, 100 |
| n47 | TDD | 5900 | U-NII-4 | n46 | 5855- | | — | 10, 20, 30, |
| | | | | | 5925 | | | 40 |
| n48 | TDD | 3500 | CBRS (US) | n77, | 3550- | | — | 5, 10, 15, |
| | | | | n78 | 3700 | | | 20, 30, 40, |
| | | | | | | | | 50, 60, 70, |
| | | | | | | | | 80, 90, 100 |
| n50 | TDD | 1500 | L-Band (EU) | | 1432- | | — | 5, 10, 15, |
| | | | | | 1517 | | | 20, 30, 40, |
| | | | | | | | | 50, 60, 80 |
| n51 | TDD | 1500 | L-Band Extension | | 1427- | | — | 5 |
| | | | (EU) | | 1432 | | | |
| n53 | TDD | 2400 | S band | | 2483.5- | | — | 5, 10 |
| | | | | | 2495 | | | |
| n54 | TDD | 1600 | L-band | | 1670- | | — | 5 |
| | | | | | 1675 | | | |
| n65 | FDD | 2100 | Extended IMT | | 1920- | 2110- | 190 | 5, 10, 15, |
| | | | | | 2010 | 2200 | | 20, 50 |
| n66 | FDD | 1700 | Extended | | 1710- | 2110- | 400 | 5, 10, 15, |
| | | 2100 | AWS | | 1780 | 2200 | | 20, 25, 30, |
| | | | | | | | | 35, 40, 45 |
| n67 | SDL | 700 | EU 700 | | — | 738- | — | 5, 10, 15, |
| | | | | | | 758 | | 20 |
| n70 | FDD | 2000 | Supplementary | | 1695- | 1995- | 300 | 5, 10, 15, |
| | | | AWS | | 1710 | 2020 | | 20, 25 |
| n71 | FDD | 600 | Digital | | 663- | 617- | −46 | 5, 10, 15, |
| | | | Dividend (US) | | 698 | 652 | | 20, 25, 30, |
| | | | | | | | | 35 |
| n72 | FDD | 450 | PMR (EU) | | 451- | 461- | 10 | 3, 5 |
| | | | | | 456 | 466 | | |
| n74 | FDD | 1500 | Lower L-Band | | 1427- | 1475- | 48 | 5, 10, 15, |
| | | | (US) | | 1470 | 1518 | | 20 |
| n75 | SDL | 1500 | L-Band (EU) | | — | 1432- | — | 5, 10, 15, |
| | | | | | | 1517 | | 20, 25, 30, |
| | | | | | | | | 40, 50 |
| n76 | SDL | 1500 | L-Band Extension | | — | 1427- | — | 5 |
| | | | (EU) | | | 1432 | | |
| n77 | TDD | 3700 | C-Band | | 3300- | | — | 10, 15, 20, |
| | | | | | 4200 | | | 25, 30, 40, |
| | | | | | | | | 50, 60, 70, |
| | | | | | | | | 80, 90, 100 |
| n78 | TDD | 3500 | C-Band | n77 | 3300- | | — | 10, 15, 20, |
| | | | | | 3800 | | | 25, 30, 40, |
| | | | | | | | | 50, 60, 70, |
| | | | | | | | | 80, 90, 100 |
| n79 | TDD | 4900 | C-Band | | 4400- | | — | 10, 20, 30, |
| | | | | | 5000 | | | 40, 50, 60, |
| | | | | | | | | 70, 80, 90, |
| | | | | | | | | 100 |
| n80 | SUL | 1800 | DCS | | 1710- | — | — | 5, 10, 15, |
| | | | | | 1785 | | | 20, 25, 30, |
| | | | | | | | | 40 |
| n81 | SUL | 900 | Extended | | 880- | — | — | 5, 10, 15, |
| | | | GSM | | 915 | | | 20 |
| n82 | SUL | 800 | Digital | | 832- | — | — | 5, 10, 15, |
| | | | Dividend (EU) | | 862 | | | 20 |
| n83 | SUL | 700 | APT | | 703- | — | — | 5, 10, 15, |
| | | | | | 748 | | | 20, 25, 30 |
| n84 | SUL | 2100 | IMT | | 1920- | — | — | 5, 10, 15, |
| | | | | | 1980 | | | 20, 25, 30, |
| | | | | | | | | 40, 50 |
| n85 | FDD | 700 | Extended | | 698 | 728- | 30 | 3, 5, 10, 15 |
| | | | Lower SMH | | 716 | 746 | | |
| n86 | SUL | 1700 | Extended | n80 | 1710- | — | — | 5, 10, 15, |
| | | | AWS | | 1780 | | | 20, 40 |
| n89 | SUL | 850 | CLR | | 824- | — | — | 5, 10, 15, |
| | | | | | 849 | | | 20, |
| n90 | TDD | 2500 | BRS | | 2496- | | — | 5, 10, 15, |
| | | | | | 2690 | | | 20, 25, 30, |
| | | | | | | | | 35, 40, 45, |
| | | | | | | | | 50, 60, 70, |
| | | | | | | | | 80, 90, 100 |
| n91 | FDD | 800 | DD (EU) L- | n20, | 832- | 1427- | 570-595 | 5, 10 |
| | | 1500 | Band (EU) | n51 | 862 | 1432 | | |
| n92 | FDD | 800 | DD (EU) L- | n20, | 832- | 1432- | 600- | 5, 10, 15, |
| | | 1500 | Band (EU) | n50 | 862 | 1517 | 660[B11] | 20 |
| n93 | FDD | 900 | Extended | n8, | 880- | 1427- | 527- | 5,10 |
| | | 1500 | GSM L-Band | n51 | 915 | 1432 | 547[B11] | |
| | | | (EU) | | | | | |
| n94 | FDD | 900 | Extended | n8, | 880- | 1432- | 532- | 5, 10, 15, |
| | | 1500 | GSM L-Band | n50 | 915 | 1517 | 632[B11] | 20 |
| | | | (EU) | | | | | |
| n95 | SUL | 2100 | IMT | | 2010- | — | — | 5, 10, 15 |
| | | | | | 2025 | | | |
| n96 | TDD | 6000 | U-NII-5-8 | | 5925- | — | — | 20, 40, 60, |
| | | | | | 7125 | | | 80, 100 |
| n97 | SUL | 2300 | S-Band | | 2300- | — | — | 5, 10, 15, |
| | | | | | 2400 | | | 20, 25, 30, |
| | | | | | | | | 40, 50, 60, |
| | | | | | | | | 70, 80, 90, |
| | | | | | | | | 100 |
| n98 | SUL | 1900 | DCS-IMT | | 1880- | — | — | 5, 10, 15, |
| | | | Gap | | 1920 | | | 20, 25, 30, |
| | | | | | | | | 35, 40 |
| n99 | SUL | 1600 | Upper L- | | 1626.5- | — | — | 5, 10 |
| | | | band (US) | | 1660.5 | | | |
| n100 | FDD | 900 | Rail Mobile | | 874.4- | 919.4- | 45 | 3, 5 |
| | | | Radio (RMR) | | 880 | 925 | | |
| n101 | TDD | 1900 | Rail Mobile | n39 | 1900- | | — | 5, 10 |
| | | | Radio (RMR) | | 1910 | | | |
| n102 | TDD | 6200 | U-NII-5 | n96 | 5925- | | — | 20, 40, 60, |
| | | | | | 6425 | | | 80, 100 |
| n104 | TDD | 6700 | U-NII-6-8 | | 6425- | | — | 20, 30, 40, |
| | | | | | 7125 | | | 50, 60, 70, |
| | | | | | | | | 80, 90, 100 |
| n105 | FDD | 600 | Digital | | 663- | 612- | −51 | 5, 10, 15, |
| | | | Dividend | | 703 | 652 | | 20, 25, 30, |
| | | | (APT) | | | | | 35 |
| n106 | FDD | 900 | LMR (US) | | 896- | 935- | 39 | 3 |
| | | | | | 901 | 940 | | |
| n109 | FDD | 700 | APT (EU) L- | | 703- | 1432- | 729 | 5, 10, 15, |
| | | 1500 | Band (EU) | | 733 | 1517 | | 20, 25, 30, |
| | | | | | | | | 40, 50 |

TABLE 2

| | | | | Uplink/ | Channel |
|---|---|---|---|---|---|
| | f | Common | Subset | Downlink | bandwidths |
| Band | (GHz) | name | of band | (GHz) | (MHz) |
| n257 | 28 | LMDS | | 26.50- | 50, 100, |
| | | | | 29.50 | 200, 400 |
| n258 | 26 | K-band | | 24.25- | 50, 100, |
| | | | | 27.50 | 200, 400 |
| n259 | 41 | V-band | | 39.50- | 50, 100, |
| | | | | 43.50 | 200, 400 |
| n260 | 39 | Ka-band | | 37.00- | 50, 100, |
| | | | | 40.00 | 200, 400 |
| n261 | 28 | Ka-band | n257 | 27.50- | 50, 100, |
| | | | | 28.35 | 200, 400 |
| n262 | 47 | V-band | | 47.20- | 50, 100, |
| | | | | 48.20 | 200, 400 |
| n263 | 60 | V-band | | 57.00- | 100, 400, |
| | | | | 71.00 | 800, 1600, |
| | | | | | 2000 |

Table 1 and 2 list the specified frequency bands and the channel bandwidths of the 5G NR standard. Note that the NR bands are defined with prefix of “n”. When the NR band is overlapping with the 4G LTE band, they share the same band number.

FIG. 5 illustrates a system 500 for MIMO (multiple input, multiple output) with 5G over coaxial cable with the systems shown herein. In FIG. 5, the system 500 provides TDD frequency conversion with MIMO.

In system 500, a RRU 505 is in communication with a TDD frequency convertor (FC) 510 via a plurality of antenna (ANT1-4). The TDD FC 510 transmits the received signals over four different frequencies f1-f4, where frequencies f1-f4 are in the cable spectrum. The signals transmitted on the frequencies f₁-f₄ are received by a combiner 515 and then combined to be transmitted to and/or over the cable network.

In operation, system 500 provides a MIMO extension for 5G over cable. Remote Radio Unit 505 outputs multiple RF streams, each delivered to TDD Frequency Converter 510. Converter 510 maps each stream into distinct cable-frequency channels f₁-f₄. The separate channels are recombined by Combiner 515 into a single HFC feed, enabling simultaneous multi-antenna transport over coaxial cable.

In at least one embodiment, the communication system 100 (shown in FIG. 1) is configured for transmitting 5G signals over a wired network. The system 100 includes a 5G radio access network (RAN) component 117 (shown in FIG. 1) including a baseband unit (BBU) 120 (shown in FIG. 1) and a remote radio unit (RRU) 125 (shown in FIG. 1) operable to output one or more 3GPP frequency band signals. The system 100 also includes a frequency converter (FC) 130 (shown in FIG. 1) in wired communication with the RRU 125, the FC 130 being operative in both time-division duplex (TDD) and frequency-division duplex (FDD) modes to convert each 3GPP frequency band signal into one or more cable-frequency bands for transport over a hybrid fiber-coaxial (HFC) network 110 (shown in FIG. 1). The system 500 further includes an optical transmitter 135 (shown in FIG. 1) to convey the converted cable-frequency bands into the HFC network 110. In addition, the system 100 includes a corresponding FC 160 (shown in FIG. 1) and at a subscriber home 150 (shown in FIG. 1) that converts the cable-frequency bands back into 3GPP frequency band signals for delivery to customer home equipment (CPE) 165 (shown in FIG. 1).

In some further embodiments, the RRU 125 outputs baseband in-phase and quadrature (I-Q) signals, and the FC 130 converts the baseband I-Q signals directly to the cable-frequency bands, bypassing intermediate 3GPP frequency bands.

In some further embodiments, the system 100 further includes a multiple input multiple output (MIMO) configuration 500. In the MIMO configuration 500, an RRU 505 outputs a plurality of RF streams. The FC 510 includes at least one additional frequency converter to map each RF stream to a distinct cable-frequency band channel, separated by a guard-band to prevent interference.

In some further embodiments, the cable-frequency bands are in a range of 5 MHz to 1.2 GHz, including a full duplex (FDX) band of 108 MHz to 684 MHz.

In some further embodiments, the system 500 further includes one or more bi-directional amplifiers 145 (shown in FIG. 1) in the HFC network 110 operable in both TDD and FDX modes. Each amplifier 145 switches between TDD and FDX based on network traffic or interference conditions. The bi-directional amplifiers 145 are configured to fall back to TDD mode from FDX mode when interference is detected. The amplifiers 145 use TDD as a mechanism to mitigate co-channel interference.

In some further embodiments, the FC 130, when operating in FDD mode, converts upstream and downstream 3GPP frequency band signals to separate cable-frequency bands, and the system 100 includes echo cancellation to suppress co-channel interference.

In another example embodiment, an amplifier apparatus 145, 240, 340, and/or 435 (shown in FIGS. 1-4, respectively) are used in a 5G over cable system 100, 200, 300, and 400 (shown in FIGS. 1-4, respectively). The apparatus 145, 240, 340, and/or 435 includes an amplifier stage operable in a full-duplex (FDX) band and in a time-division duplex (TDD) band. The apparatus 145, 240, 340, and/or 435 also includes an echo cancellation (EC) system coupled to both upstream and downstream paths to suppress interferences when downstream signals and upstream signals overlap. The apparatus further includes 145, 240, 340, and/or 435 a control module for time switching amplification between transmit and receive modes in TDD operation. The control module being responsive to a synchronization signal or to signal detectors that enable amplification only when a corresponding signal is present.

In some further embodiments, the echo cancellation system is configured to suppress interference by at least 30 dB to maintain a modulation error ratio (MER) greater than 40 dB.

In some further embodiments, the control module synchronizes time switching in TDD mode according to 3GPP 5G specifications, to align with a timing requirement of a cable network.

In some further embodiments, the control module includes signal detectors that initiate amplification in TDD mode only when a downstream or upstream signal is detected.

In some further embodiments, the amplifier stage is configured to merge TDD and FDX operations in the FDX band by selectively applying time-switching for TDD traffic and simultaneous amplification with echo cancellation for FDX traffic.

In some further embodiments, the control module is configured to switch the amplifier stage to TDD mode as a fallback from FDX mode in response to detected interference.

In some further embodiments, the amplifier stage is further operable in a frequency-division duplex (FDD) band, amplifying upstream and downstream signals in separate frequency bands with echo cancellation to suppress interference.

In some further embodiments, the amplifier stage is configured to amplify multiple RF streams in a multiple input multiple output (MIMO) configuration, each stream occupying a distinct cable-frequency band channel.

In a further example, a combined 5G radio and cable network system 100 is created. The system 100 includes a 5G core 115 and RAN equipment 117 shared by both a wireless physical interface and a cable-frequency physical interface. The RAN equipment 117 includes a baseband unit 120 and a radio receiving unit 125. The system also includes one or more frequency converters 130 and 160 that selectively route 3GPP signals to either a wireless antenna or into a cable. The system further includes customer premises equipment (CPE) 165 operable to receive 5G signals via either the wireless physical interface or the cable-frequency physical interface.

In some further embodiments, a switch is configured to selectively route the 3GPP signals to either a wireless antenna or the cable based on network demand or signal quality.

In some further embodiments, the CPE 165 implements a 5G protocol to process the signals received via the wireless physical interface or the cable-frequency physical interface.

In some further embodiments, the RAN equipment 117 includes a RRU 125 to output multiple RF streams for multiple input multiple output (MIMO) operation. In these embodiments, the frequency converters 130 and 165 map each RF stream to a distinct cable-frequency band channel for transmission over the cable network.

In some further embodiments, the system 100 supports a hybrid architecture allowing simultaneous transmission of 5G signals over both the wireless physical interface and the cable-frequency physical interface. The CPE 165 selects the wireless physical interface or the cable-frequency physical interface based on signal strength or latency.

### Additional Considerations

As will be appreciated based upon the foregoing specification, the above-described embodiments of the disclosure may be implemented using computer programming or engineering techniques including computer software, firmware, hardware or any combination or subset thereof. Any such resulting program, having computer-readable code means, may be embodied or provided within one or more computer-readable media, thereby making a computer program product, i.e., an article of manufacture, according to the discussed embodiments of the disclosure. The computer-readable media may be, for example, but is not limited to, a fixed (hard) drive, diskette, optical disk, magnetic tape, semiconductor memory such as read-only memory (ROM), and/or any transmitting/receiving medium such as the Internet or other communication network or link. The article of manufacture containing the computer code may be made and/or used by executing the code directly from one medium, by copying the code from one medium to another medium, or by transmitting the code over a network.

These computer programs (also known as programs, software, software applications, “apps,” or code) include machine instructions for a programmable processor and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The “machine-readable medium” and “computer-readable medium,” however, do not include transitory signals. The term “machine-readable signal” refers to any signal used to provide machine instructions and/or data to a programmable processor.

In one implementation, the radio frequency (RF) communications management module includes a 3GPP Fifth Generation New Radio (5G NR) gNB (gNodeB) Controller Unit (CU), the first data interface for data communication with a network core process includes a 3GPP Fifth Generation New Radio (5G NR) Xn interface with a 5GC (Fifth Generation Core), and the second data interface includes a 3GPP Fifth Generation New Radio (5G NR) F1 interface operative over at least a wireline data bearer medium, the first RF distribution node including a 3GPP Fifth Generation New Radio (5G NR) gNB (gNodeB) Distributed Unit (DU); and the third data interface includes an Fifth Generation New Radio (5G NR) F1 interface operative over at least a dense wave division multiplexed (DWDM) optical data bearer, the second RF distribution node including a 3GPP Fifth Generation New Radio (5G NR) gNB (gNodeB) Distributed Unit (DU).

In some embodiments, the terms used herein are the equivalent of those used in an Open RAN Architecture, such as described by the O-RAN Alliance. This is a 5G Architecture. In these embodiments, the BBU includes a CU and a DU. Furthermore, the RRU is known as RU. Additionally, the eCPRI interface is known as the 7.2 Interface. One having skill in the art would understand that these systems and methods would also work with other types of signals and/or protocols. Accordingly, these terms may be used interchangeably with the systems and methods described herein.

As used herein, the term “database” can refer to either a body of data, a relational database management system (RDBMS), or to both. As used herein, a database can include any collection of data including hierarchical databases, relational databases, flat file databases, object-relational databases, object-oriented databases, and any other structured collection of records or data that is stored in a computer system. The above examples are example only, and thus are not intended to limit in any way the definition and/or meaning of the term database. Examples of RDBMS' include, but are not limited to including, Oracle® Database, MySQL, IBM® DB2, Microsoft® SQL Server, and PostgreSQL. However, any database can be used that enables the systems and methods described herein. (Oracle is a registered trademark of Oracle Corporation, Redwood Shores, California; IBM is a registered trademark of International Business Machines Corporation, Armonk, New York; and Microsoft is a registered trademark of Microsoft Corporation, Redmond, Washington.)

As used herein, a processor may include any programmable system including systems using micro-controllers, reduced instruction set circuits (RISC), application specific integrated circuits (ASICs), logic circuits, and any other circuit or processor capable of executing the functions described herein. The above examples are example only and are thus not intended to limit in any way the definition and/or meaning of the term “processor.”

As used herein, the terms “software” and “firmware” are interchangeable and include any computer program stored in memory for execution by a processor, including RAM memory, ROM memory, EPROM memory, EEPROM memory, and non-volatile RAM (NVRAM) memory. The above memory types are example only and are thus not limiting as to the types of memory usable for storage of a computer program.

In another example, a computer program is provided, and the program is embodied on a computer-readable medium. In an example, the system is executed on a single computer system, without requiring a connection to a server computer. In a further example, the system is being run in a Windows® environment (Windows is a registered trademark of Microsoft Corporation, Redmond, Washington). In yet another example, the system is run on a mainframe environment and a UNIX® server environment (UNIX is a registered trademark of X/Open Company Limited located in Reading, Berkshire, United Kingdom). In a further example, the system is run on an iOS® environment (iOS is a registered trademark of Cisco Systems, Inc. located in San Jose, CA). In yet a further example, the system is run on a Mac OS® environment (Mac OS is a registered trademark of Apple Inc. located in Cupertino, CA). In still yet a further example, the system is run on Android® OS (Android is a registered trademark of Google, Inc. of Mountain View, CA). In another example, the system is run on Linux® OS (Linux is a registered trademark of Linus Torvalds of Boston, MA). The application is flexible and designed to run in various different environments without compromising any major functionality.

In some embodiments, the system includes multiple components distributed among a plurality of computing devices. One or more components may be in the form of computer-executable instructions embodied in a computer-readable medium. The systems and processes are not limited to the specific embodiments described herein. In addition, components of each system and each process can be practiced independent and separate from other components and processes described herein. Each component and process can also be used in combination with other assembly packages and processes.

As used herein, an element or step recited in the singular and proceeded with the word “a” or “an” should be understood as not excluding plural elements or steps, unless such exclusion is explicitly recited. Furthermore, references to “example” or “one example” of the present disclosure are not intended to be interpreted as excluding the existence of additional examples that also incorporate the recited features. Further, to the extent that terms “includes,” “including,” “has,” “contains,” and variants thereof are used herein, such terms are intended to be inclusive in a manner similar to the term “comprises” as an open transition word without precluding any additional or other elements.

Furthermore, as used herein, the term “real-time” refers to at least one of the time of occurrence of the associated events, the time of measurement and collection of predetermined data, the time to process the data, and the time of a system response to the events and the environment. In the examples described herein, these activities and events occur substantially instantaneously.

The patent claims at the end of this document are not intended to be construed under 35 U.S.C. § 112(f) unless traditional means-plus-function language is expressly recited, such as “means for” or “step for” language being expressly recited in the claim(s).

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A communication system for transmitting 5G signals over a wired network, the system comprising:
a 5G radio access network (RAN) component including a baseband unit (BBU) and a remote radio unit (RRU) operable to output one or more 3GPP frequency band signals;
a frequency converter (FC) in wired communication with the RRU, the FC being operative in both time-division duplex (TDD) and frequency-division duplex (FDD) modes to convert each 3GPP frequency band signal into one or more cable-frequency bands for transport over a hybrid fiber-coaxial (HFC) network;
an optical transmitter to convey the converted cable-frequency bands into the HFC network; and
a corresponding FC at a subscriber home that converts the cable-frequency bands back into 3GPP frequency band signals for delivery to customer home equipment (CPE).

2. The system of claim 1, wherein the RRU outputs baseband in-phase and quadrature (I-Q) signals, and the FC converts the baseband I-Q signals directly to the cable-frequency bands, bypassing intermediate 3GPP frequency bands.

3. The system of claim 1, further comprising a multiple input multiple output (MIMO) configuration, wherein the RRU outputs a plurality of RF streams, and the FC includes at least one additional frequency converter to map each RF stream to a distinct cable-frequency band channel, separated by a guard-band to prevent interference.

4. The system of claim 1, wherein the cable-frequency bands are in a range of 5 MHz to 1.2 GHz, including a full duplex (FDX) band of 108 MHz to 684 MHz.

5. The system of claim 1, further comprising one or more bi-directional amplifiers in the HFC network operable in both TDD and FDX modes, wherein each amplifier switches between TDD and FDX based on network traffic or interference conditions.

6. The system of claim 5, wherein the bi-directional amplifiers are fall back to TDD mode from FDX mode when interference is detected, using TDD as a mechanism to mitigate co-channel interference.

7. The system of claim 1, wherein the FC, when operating in FDD mode, converts upstream and downstream 3GPP frequency band signals to separate cable-frequency bands, and the system includes echo cancellation to suppress co-channel interference.

8. An amplifier apparatus for use in a 5G over cable system, the apparatus comprising:
an amplifier stage operable in a full-duplex (FDX) band and in a time-division duplex (TDD) band;
an echo cancellation (EC) system coupled to both upstream and downstream paths to suppress interferences when downstream signals and upstream signals overlap; and
a control module for time switching amplification between transmit and receive modes in TDD operation, the control module being responsive to a synchronization signal or to signal detectors that enable amplification only when a corresponding signal is present.

9. The apparatus of claim 8, wherein the echo cancellation system is configured to suppress interference by at least 30 dB to maintain a modulation error ratio (MER) greater than 40 dB.

10. The apparatus of claim 8, wherein the control module synchronizes time switching in TDD mode according to 3GPP 5G specifications, to align with a timing requirement of a cable network.

11. The apparatus of claim 8, wherein the control module includes signal detectors that initiate amplification in TDD mode only when a downstream or upstream signal is detected.

12. The apparatus of claim 8, wherein the amplifier stage is configured to merge TDD and FDX operations in the FDX band by selectively applying time-switching for TDD traffic and simultaneous amplification with echo cancellation for FDX traffic.

13. The apparatus of claim 8, wherein the control module is configured to switch the amplifier stage to TDD mode as a fallback from FDX mode in response to detected interference.

14. The apparatus of claim 8, wherein the amplifier stage is further operable in a frequency-division duplex (FDD) band, amplifying upstream and downstream signals in separate frequency bands with echo cancellation to suppress interference.

15. The apparatus of claim 8, wherein the amplifier stage is configured to amplify multiple RF streams in a multiple input multiple output (MIMO) configuration, each stream occupying a distinct cable-frequency band channel.

16. A combined 5G radio and cable network system, the system comprising:
a 5G core and RAN equipment shared by both a wireless physical interface and a cable-frequency physical interface, wherein the RAN equipment includes a baseband unit and a radio receiving unit;
one or more frequency converters that selectively route 3GPP signals to either a wireless antenna or into a cable; and
customer premises equipment (CPE) operable to receive 5G signals via either the wireless physical interface or the cable-frequency physical interface.

17. The system of claim 16, further comprising a switch configured to selectively route the 3GPP signals to either a wireless antenna or the cable based on network demand or signal quality.

18. The system of claim 16, wherein the CPE implements a 5G protocol to process the signals received via the wireless physical interface or the cable-frequency physical interface.

19. The system of claim 16, wherein the RAN equipment includes a RRU to output multiple RF streams for multiple input multiple output (MIMO) operation, and the frequency converters map each RF stream to a distinct cable-frequency band channel for transmission over the cable network.

20. The system of claim 16, wherein the system supports a hybrid architecture allowing simultaneous transmission of 5G signals over both the wireless physical interface and the cable-frequency physical interface, wherein the CPE selects the wireless physical interface or the cable-frequency physical interface based on signal strength or latency.
